(19) United States
(12) Patent Application Publication
(10) Pub. No.: US 2010/0219034 A1
(43) Pub. Date: Sep. 2, 2010

(54) CONTROL ASSEMBLY

(75) Inventors: Jonathan Charles Wheals, Warwickshire (GB); Nicholas Jackson, West Midlands (GB)

Correspondence Address: GIFFORD, KRASS, SPRINKLE,ANDERSON & CITKOWSKI, P.C, PO BOX 7021, TROY, MI, 48007-7021, US

(73) Assignee: Ricardo UK Ltd., West Sussex (GB)

(21) Appl. No.: 12/067,135

(22) PCT Filed: Sep. 25, 2006
(86) PCT No.: PCT/GB2006/003539

§ 371 Date: Mar. 17, 2008

(30) Foreign Application Priority Data
Sep. 26, 2005 (GB) 0519546.6
Oct. 24, 2005 (GB) 0521627.0

(51) Int. Cl. F16D 21/00; F16D 19/00

(52) U.S. Cl. 192/48.1; 192/82 R; 192/93 A

(57) ABSTRACT

A control assembly (10) for controlling the actuation of two clutch packs (50, 52) includes a motor (12) for driving an annular gear wheel (24). Radial pins (30) project from the gear wheel to engage concentric pistons (34, 36) arranged for linear movement relative to one another along the axis of rotation of the gear wheel. Each piston includes slots (40) which define cam surfaces for engagement by the drive pins. Rotation of the gear wheel in first direction causes the pins to drive against cam surfaces on the inner piston, to drive the inner piston towards the inner clutch. Rotation of the gear wheel in the opposite direction causes the pins to drive against cam surfaces on the outer piston, to drive the outer piston towards the outer clutch.

The present invention relates to a control arrangement or assembly. More particularly, but not exclusively, the invention relates to a control arrangement or assembly for controlling the actuation of two clutches, for example in a torque biasing device provided for distributing torque between the wheels of a motor vehicle.

Techniques for variable torque biasing are typically used in motor vehicles to increase the proportion of drive torque directed to one of two drive shafts. A device for varying left/right drive torque to wheels of a motor vehicle is described in EP-A-0575121.

A further variable torque biasing device is known from the applicant's co-pending International patent application, PCT/GB2005/002956. This device utilises an arrangement of clutches to increase and/or reduce the speed of certain gear train elements, thereby to direct an increased proportion of torque to one drive shaft rather than another.

There is a need for other means of controlling the actuation of these clutches.

According to a first aspect of the invention, there is provided a control assembly having an input and an output, a transmission member operable to rotate in response to actuation from said input, a drive member arranged for rotation with the transmission member, and a control member arranged for operative contact with said drive member, wherein the control member is arranged to be displaced axially by the drive member in response to rotation of said transmission member, for actuation of said output.

In one embodiment, the control member is concentric with the axis of movement of the transmission member, and the transmission member is preferably a ring gear annular to said control member. The control member preferably includes a cam track for engagement by the drive member, wherein the cam track is configured so as to cause movement of the control member in a first axial direction in response to rotation of the transmission member in a first rotary direction. Furthermore, the cam track may be configured to cause axial movement of the control member in a return direction in response to rotation of the transmission member in a second rotary direction which is opposite to said first rotary direction.

The control member may take the form of a piston, and may be arranged for actuation of an automotive clutch or brake mechanism, for example.

In a preferred embodiment, the assembly may have two outputs, each having its own control member arranged for engagement with said drive member. The assembly is preferably provided for controlling the actuation of a pair of concentric clutches or other such devices providing a braking force. Beneficially, the assembly is preferably arranged to ensure the operation of the clutches is mutually exclusive, that is that only one clutch may be actuated at once.

Conveniently, the drive member may act upon double-sided cam tracks on the or each control member, to provide positive motion of the control member in both directions of axial motion. However, single-sided tracks may be preferred, in which case the assembly may be include spring elements to provide a return force to return the control member to a normal rest position after actuation by said drive member.

According to another aspect of the invention, there is provided a control assembly having an input, a transmission member operable to move about an axis in response to actuation from said input, a drive member arranged for movement with the transmission member, and a control member arranged for operative contact with said drive member, wherein the control member is arranged to be displaced axially by the drive member in response to movement of said transmission member, wherein the control assembly has two outputs, each output having its own axially movable control member arranged for operative engagement with said drive member for actuation thereof.

In one embodiment, the control members are co-axial, each defining a race for receiving a ball or roller type element, the races being co-axial, with a first race radially spaced from the other race, and wherein the drive member includes a first and second ball or roller type elements, the first element being arranged to move within the first race, and the second element being arranged to move within the other race, each race defining a cam track so as to be operable to drive the associated drive member in an axial direction in response to rotation of the drive member.

According to a still further aspect of the invention, there is provided a control assembly for a pair of concentric clutches, the control assembly having a single input and a pair of outputs, each output arranged for actuation of a respective one of said clutches, a gear portion operable to rotate in response to actuation from said input, a drive member arranged for rotation with the gear portion, and a pair of axially movable control members arranged for operative contact with said drive member, the control members being concentric with one another and said gear portion, wherein a first one of said control members is arranged to be displaced axially by the drive member in response to movement of said gear portion in a first rotary direction, and the other of said control members is arranged to be axially displaced by the drive member in response to movement of said gear portion in a second rotary direction, opposite to said first rotary direction, for actuation of their respective outputs.

The control members are preferably concentrically mounted about a drive shaft in a vehicle transmission, and the clutches are preferably provided for controlling the torque in a differential module for said drive shaft.

Other aspects and preferred features of the invention will be readily apparent to the skilled addressee from the claims and the following description, which is made, by way of example only, with reference to the accompanying drawings, in which:

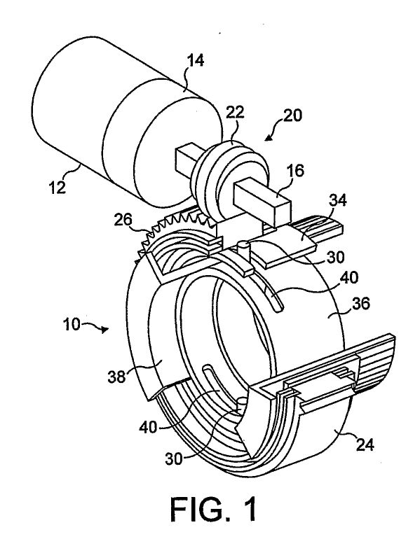

FIG. 1 is a schematic perspective view of a control assembly in accordance with a preferred embodiment of the invention;

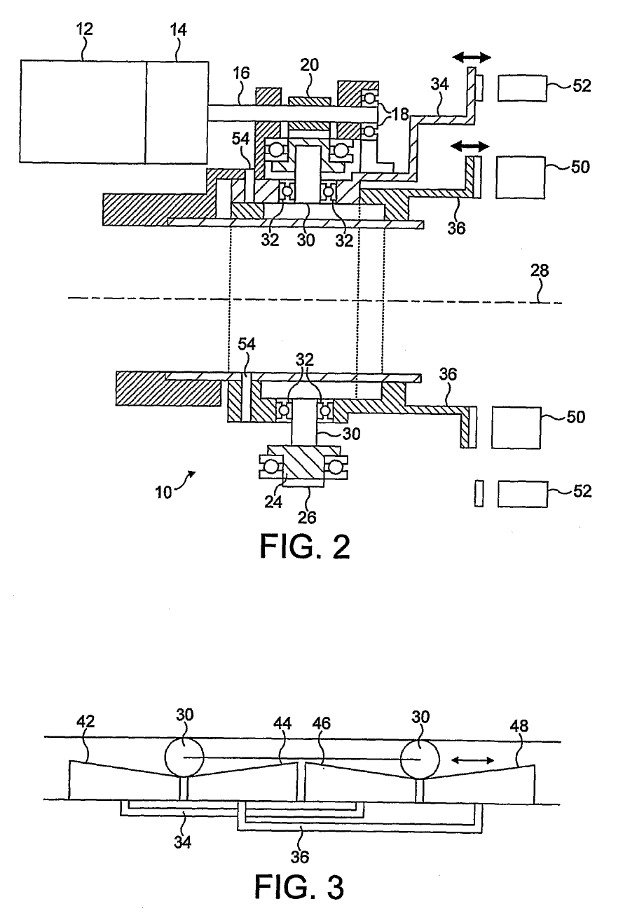

FIG. 2 is a diagrammatic view of the control assembly of FIG. 1;

FIG. 3 is a diagrammatic linear view of a roller carriage for use in FIGS. 1 and 2;

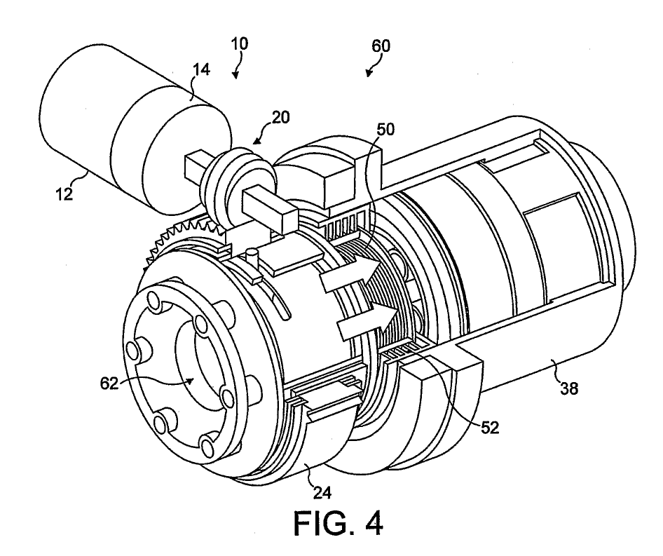

FIG. 4 is a schematic perspective view of a transmission arrangement incorporating the assembly of FIG. 1;

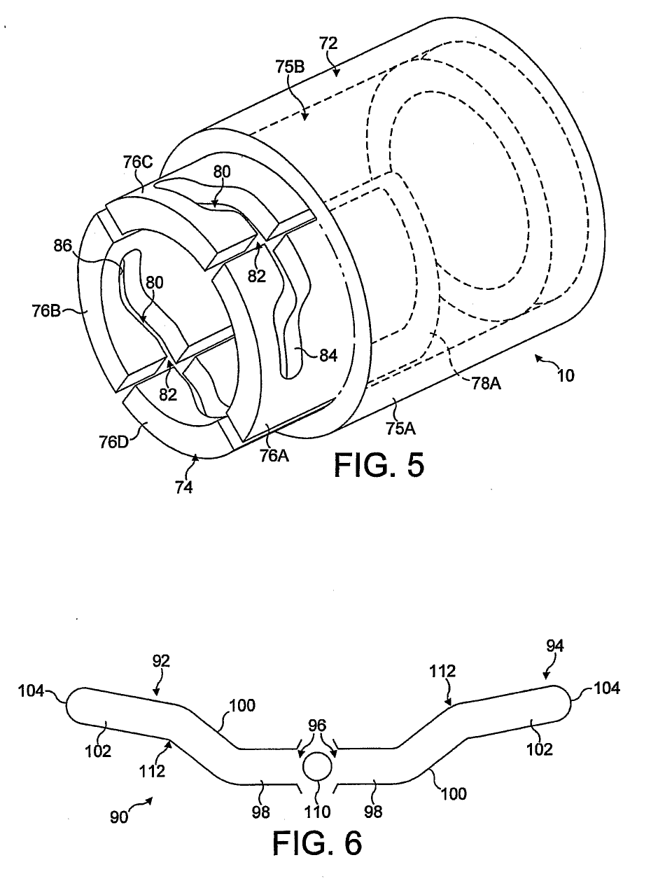

FIG. 5 is a schematic perspective view of part of a control assembly according to a further preferred embodiment of the invention;

FIG. 6 is a schematic linear view of a cam track for use in the invention; and

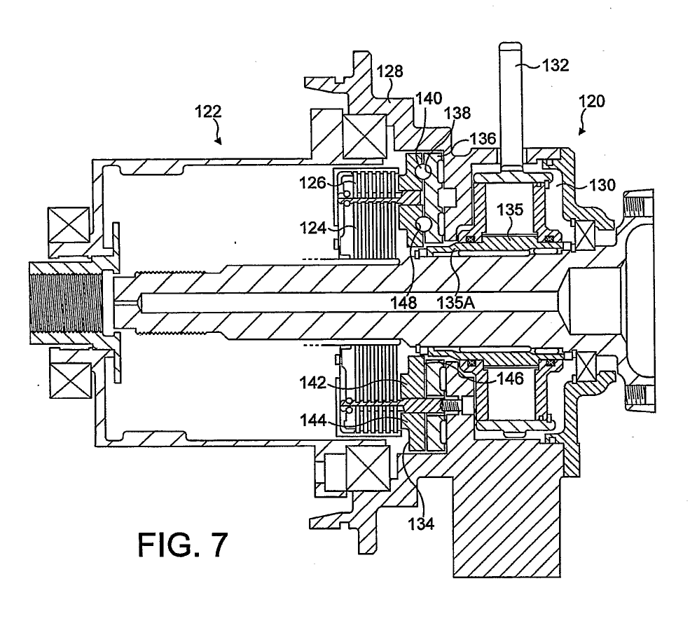

FIG. 7 is a cross-sectional schematic view of a still further embodiment of the invention.

A control assembly for controlling the actuation of two clutch packs is indicated generally at 10 in FIGS. 1 and 2. As can be seen from FIG. 2, the clutch packs are concentric, thereby defining an inner clutch 50 and an outer clutch 52. The clutches 50, 52 are arranged for use as brakes in a vehicle differential assembly. As such, the assembly 10 is arranged for selectively controlling the speed or torque of the wheels either side of a drive axle.

The assembly 10 includes a motor 12 and a reduction device, in the form of a epicyclic gearbox 14, which acts as an input for rotating a pinion 16 in a bearing 18. A wormwheel 20 having an outer drive formation 22 of known construction is fixedly mounted on the pinion 16 for rotation therewith.

A transmission member in the form of an annular gear wheel 24 having outer teeth 26 is arranged in operative engagement with the wormwheel 20. In particular, the drive formation 22 on the worm wheel 20 is arranged in mesh with the teeth 26 on the gear wheel 24, whereby rotation of the wormwheel 20 causes rotation of the gear wheel 24 about a central axis indicated at 28 in FIG. 2. The teeth may be formed on an internal or external surface of the transmission member.

The assembly 10 has drive members in the form of a pair of drive pins 30, which project radially from the gear wheel 24, diametrically opposite to one another. The drive pins 30 are rotatably mounted in bearings 32.

The assembly 10 further includes control members in the form of a pair of concentric tubular pistons 34, 36, which are arranged on either side of fixed tubular member 38. The pistons 34, 36 are fixed against rotation relative to one another, the gear wheel 24 and the fixed member 38, for example by pins 54. However, the pistons 34, 36 are arranged for linear movement relative to one another along the axis of rotation of the gear wheel 24.

Each piston 34, 36 includes a pair of slots 40 which are arranged diametrically opposite one another. The slots 40 are provided for receiving a distal portion of a respective drive pin 30. It will be appreciated that the fixed member 38 therefore also includes slots (not shown) to enable the drive pins 30 to extend through the fixed member 38 and into the innermost piston 36.

Although not shown in FIGS. 1 and 2, the slots 40 define a cam surface for engagement by the drive pins 30. An example of a cam profile for use in the invention is shown in FIG. 3, wherein each slot defines a ramp surface 42, 44, 46, 48. As will be described in more detail below, the drive pins 30, which may carry bearings, are caused to engage with the respective ramp surfaces during rotation of the gear wheel 24 in a predetermined direction.

The assembly 10 is arranged to control the force applied to the two clutch packs 50, 52 independently of one another, as follows.

If the motor 12 is driven to cause the gear wheel 24 to rotate in a clockwise direction, the pins 30 on the gear wheel 24 are brought into engagement with the cam surfaces 44, 48 of the slots 40 in the inner piston 36. Since the piston 36 is rotationally fixed, the engagement between the drive pins 30 and the cam surfaces during rotation of the gear wheel 24 causes the inner piston 36 to slide forwards within the fixed member 38, to the right as viewed in FIG. 1, thereby generating an output clamping force in the inner clutch 50.

However, if the motor 12 was instead driven to cause the gear wheel 24 to first rotate in an anticlockwise direction, the pins 30 would be brought into engagement with the cam surfaces 42, 46 of the slots 40 in the outer piston 34. Again, because the piston 34 is unable to rotate, the engagement between the drive pins 30 and the cam surfaces 42, 46 during rotation of the gear wheel 24, causes the outer piston 34 to slide on the fixed member 38, to the right as viewed in FIG. 1, thereby generating a clamping force in the outer clutch 52.

Typically, the gear wheel 24 will be caused to rotate by 45 degrees in the respective direction from a normal rest position in which no force is transmitted via the pistons, 34, 36. As will be appreciated, it is not possible to create a clamping force in both clutches 50, 52 at the same time using the assembly 10.

It should be noted that the cam surface can be provided with a low friction coating, such as a PTFE coating.

The device is advantageously suited for use in vehicle differential arrangements for controlling torque bias between the wheels on either side of an axle. An example is shown in FIG. 4, wherein the assembly is mounted on one end of a transmission housing 60 of the kind described in FIG. 23 of the applicant's co-pending International patent application, PCT/GB2005/002956. The pistons 34, 36 and gear wheel 24 are concentric and annular to an output shaft aperture 62 of the transmission, wherein the clutches 50, 52 are also annular to the output shaft, and mounted in the left hand end of the housing 60. A differential module is mounted in the right hand end of the transmission housing 60, with a gear module arranged in between the clutches 50, 52 and the differential module. The fixed member 38 of FIG. 1 extends into the transmission housing 60 and acts as a grounding element for both clutches 50, 52. The assembly 10 therefore provides a compact electromechanical actuation module for controlling the braking effect of the clutches 50, 52 in the transmission housing 60.

The assembly 10 is also suited for other on-demand couplings, for example, in vehicle drive lines.

The assembly 10 preferably includes sensors, for example continuous position sensors including potentiometer encoders, discrete position sensors, temperature sensors, pressure sensors, force sensors and torque sensors, including magnetostrictive, magneto-resistive and surface acoustic wave types.

An ECU control unit (not shown) is arranged to monitor signals from the sensors, and to apply stored algorithms to modulate actuation of either of the two clutches 50, 52, accordingly.

An alternative arrangement is indicated generally at 70 in FIG. 5.

The arrangement 70 includes a first piston 72 for actuating a first output device, and a second piston 74 for actuating a second output device. As can be seen clearly in FIG. 5, the second piston 74 is arranged inside and concentric with the first piston 72.

In use, the pistons 72 and 74 are mounted in and/or on a housing (not shown), with both pistons 72, 74 being arranged for reciprocal axial movement relative to said housing. More particularly, the pistons 72, 74 are intended to be arranged for axial movement relative to one another, left to right as viewed in FIG. 5, in response to relative rotational movement of a ring gear or other such drive arrangement, for example of the kind described above with reference to FIGS. 1 to 4.

It should be noted that the pistons 72, 74 are prevented from rotation relative to one another and relative to their housing, so as to be movable in the axial direction only. For example, the outer piston 72 may include a key which is slidably received in a groove on the internal surface of the inner piston, or vice versa, for enabling relative movement of the pistons 72, 74 in the axial direction only. A similar arrangement can be provided between the outer piston 72 and the housing and/or between the inner piston 74 and a further fixed member arranged on the inner side of the inner piston 74.

Each piston 72, 74 defines a generally tubular body 75 having a pair of diametrically opposed control portions 76 extending from a first end thereof, to the left as viewed in FIG. 5.

The control portions 76A, 76B on the outer piston 72 are radially offset from the body 75A of the outer piston 72, so as to extend generally inwards relative thereto. As such, the control portions 76A, 76B define an outer diameter which is smaller than the outer diameter of the body 75A.

The control portions 76C, 76D on the inner piston 74 are coextensive with the body 75B, so as to define an outer diameter which is the same as the outer diameter of the body 75B.

As can be seen in FIG. 5, the outer diameter defined by the control portions 76A, 76B on the outer piston 72 is the same as the outer diameter of the control portions 76C, 76D on the inner piston 74. As such, the four control portions define the same circumference, with the control portions 76A, 76B arranged between the control portions 76C, 76D.

It should be noted that the inner piston 74 defines a pair of diametrically opposed recesses, only one of which is visible in FIG. 5, indicated at 78. The recesses 78 extend axially in the body 75 of the inner piston 74, and are configured to enable the inwardly directed control portions 76A, 76B of the outer piston 72 to move axially relative to the inner piston 74, to the right as viewed in FIG. 5, without abutment with the inner piston 74. In particular, each recess 78 is aligned with a respective control portion 76A, 76B, so that the control portions 76A, 76B can travel within the recesses 78, if moved axially to the right from the position shown in FIG. 5.

Each control portion 76 includes a control track configured for receiving a drive member, for example a drive pin of the kind described above with reference to FIGS. 1 to 4.

In this embodiment, the control tracks are in the form of slots 80. Each slot defines a mouth 82, wherein the mouth 82 of a slot 80 on the inner piston 74 is arranged radially opposite the mouth 82 of a slot 80 on the outer piston 72, as can be seen clearly in FIG. 5.

Each slot 80 defines a cam surface 84 for engagement by a drive member, so as to cause the respective piston 72, 74 to move in an axial direction, as will be described in more detail below.

In a preferred embodiment, the arrangement 70 is mounted in communication with the ring gear 24 of FIGS. 1 to 4, that is to say with a pair of diametrically opposite drive pins extending from the ring gear. In a normal rest condition, the drive pins on the ring gear adopt a passive position between the respective opposing mouths 82 of the slots 80, wherein no axial drive force is transmitted between the ring gear and pistons 72, 74. However, upon rotation of the ring gear in a predetermined direction, each drive pin is caused to move into a respective slot 80, and to engage with a first portion of the cam surface 84, e.g. the portion of the cam surface 84 directly adjacent the mouth 82 of the slot 80. With continued rotation in the same direction, the drive pins progress along their respective slot 80, in engagement with the respective cam surface. 84, until the drive pin abuts the end of the slot 80. At that stage, further rotation of the ring gear is prevented.

The cam surfaces 84 are arranged so that the engagement with the drive pins during rotational of the ring gear will one of said pistons 72, 74 to move axially with respect to the other piston 72, 74. As such, only one piston 72, 74 can be moved at a time.

In this embodiment, the slots 82 are double sided, so as to define a pair of opposing cam surfaces; a drive surface 84 for movement of the respective pistons 72, 74 in an active direction (to the right as viewed in FIG. 5), and a return surface 86 for movement of the pistons 72, 74 in return direction (to the left as viewed in FIG. 5).

Hence, during rotation of the ring gear in a first direction, one of said pistons is caused to move in an active direction, due to the force transmitted between the drive pins and the drive surfaces 84 on said piston. If the ring gear is then rotated in the opposite direction by the same amount, the drive pins will engage the return surfaces 86 of the respective piston, to cause the piston to be returned to its original position. Continued rotation of the ring gear in said opposite direction will then cause the drive pins to engage the drive surfaces 84 in the other piston, to cause said other piston to be moved in the active direction, and so forth.

The arrangement 70 is preferably operable so that maximum movement of each piston in the active direction is achieved after 45 degrees of rotation of the ring gear in the respective direction, and vice versa.

The cam surfaces 84, 86 can be configured to vary or interrupt the rate of axial movement of the pistons, so as to modulate the output from the control assembly, as required.

An example of a cam configuration for use in modulating the actuation of a pair of concentric, multi-plate wet clutches is illustrated schematically in FIG. 6, indicated generally at 90.

A pair of opposing cam slots 92, 94 are shown, wherein one slot 92 is intended to be arranged on a first piston, with the other slot 94 arranged on a second piston. The first piston is intended to be operable for actuating an outer clutch pack, with the second piston operable for actuating an inner clutch pack. The two slots 92, 94 are symmetrical, with each having a mouth 96, a generally horizontal travel portion 98, an first angled travel portion 100, a second angled travel portion 102 and an end surface 104. Furthermore, the slots 92, 94 each define a drive surface 106 and a return surface 108.

The width of the slots 92, 94 is configured for receiving the end of a drive pin 110 mounted on a ring gear, for example of the kind described above with reference to FIGS. 1 to 4.

In use, the drive pin 110 is caused to enter the mouth 96 of one of the slots 92, 94, to the left or right as viewed in FIG. 6, by rotation of the ring gear in a first direction. As the ring gear rotates, the drive pin 110 is caused to move within said slot until it reaches the end surface 104, whereby further rotation of the drive pin 110 is then prevented.

During movement towards the end surface 104, the drive pin 110 first passes along the horizontal travel portion 98. It will be appreciated that no substantial force is transmitted to the drive surface 106 during this movement, so that the respective piston is not caused to move in the active direction. The horizontal travel portion 98 therefore acts as a ‘hold off’ zone, which is provided to prevent unintentional actuation of the piston due to external excitation, for example if the vehicle is travelling over rough terrain.

As the pin 110 enters the first angled travel portion 100, it is caused to engage the drive surface 106. Because the piston is rotationally fixed, the piston is axially displaced in the active direction due to forces transmitted by the drive pin.

The first angled travel portion 100 defines a ramp along which the drive pin 110 must pass during rotation of the gear wheel in the first direction, at all times imparting force on to the drive surface 106, to cause axial displacement of the piston. As can be seen, the ramp is relatively steep, which ensures that the axial displacement occurs quickly. In use, this steep section is utilised to take up quickly any play between the clutch plates in the respective clutch pack, before load is transmitted to the clutch pack.

Continued rotation of the ring gear in the first direction causes the drive pin 110 to enter the second angled travel portion 102 of the slot 92. As can be seen, the second angled travel portion 102 also defines a ramp along which the pin 110 must pass. However, the ramp angle is less than that of the first angled travel portion 100, so as to slow down the rate of axial displacement of the piston. The reduction in the rate of axial displacement enables the load from the piston to be imparted to the clutch pack in a controlled manner.

As can be seen, there is a curved transition between the first and second angled travel portions 100, 102, to control the rate of change of axial displacement between the take up phase and the load phase, so as to reduce shock during actuation of the clutch pack.

When it is desired to release the load on the clutch pack, the ring gear must be caused to rotate in the opposite direction, so as to return the drive pin 110 back along the slot 92 to a normal rest position between the two slots 92, 94.

As the drive pin 110 returns along the slot 92, it engages the return surface 106 of the second and first angled travel portions 102, 100, respectively, which causes the piston to be displaced axially in the opposite direction. During the shallower ramp section, the load on the clutch pack is released in a controlled manner. As the pin 110 enters the horizontal travel section, the pin 110 disengages the return surface 106 so as to prevent further axial displacement of the piston in the return direction.

It will be appreciated that the axial displacement process is the same for the other slot 94, during rotation of the ring gear in the opposite direction.

It will be appreciated that the configuration of the cam surfaces on the first piston can be different to the cam surfaces on the other piston, as required. Indeed, it may be preferable to have a drive surface which differs in profile from the return surface in any given piston.

The described arrangements are not limited in application to concentric clutches of the kind described above, nor are they limited to use in automotive technologies. It will be appreciated that the arrangements are applicable for controlling the actuation of various types of output devices, in particular those which require axial actuation or movement, and more particularly those having a high actuator force requirement. These may take the form of part of an electrical machine, for example. The arrangements can be utilised to control the movement of two hydraulic pistons, whether concentric or otherwise arranged, for controlling the stroke thereof, with a respective output coupled to or consisting of a portion of each piston. The arrangements can also be used in twin clutch transmissions (DCT), wherein the modulation of one clutch is completed before actuation of the other. Other dual braking, -clutching or -clamping applications will be readily apparent to the skilled addressee.

The arrangements are advantageous in that they can be operated using a single input mechanism. The input preferably comprises at least one rotary motor, for example a brushed or brushless DC type motor, and may include a speed reducing device such as an epicyclic gearbox, and a worm and wheel gear input. The input may be an electric, hydraulic or pneumatic motor, for example.

The arrangement may include only a single control member for actuation of a single output, wherein the control member is engagable by at least one drive member for axial movement thereof.

The transmission member may take the form of a non-annular device, for example a sector of a planar gear wheel, which is arranged to pivot about an axis, said axis preferably being concentric with the control member(s).

The or each drive member may take the form of a ball or roller type element, coupled with or attached to the transmission member, and configured to be movably received in a cam track on the or each control member. Alternatively, the drive member may take the form of a tooth or lug integrally formed on the transmission member, for example.

An embodiment of a control assembly utilising ball type drive elements is illustrated in FIG. 7, indicated generally at 120.

The control assembly 120 is shown in communication with a variable torque biasing device 122 generally of a kind described in the applicant's co-pending International patent application, PCT/GB2005/002956, and as illustrated in FIG. 4 of the present application. In the main, the internal components of the variable torque biasing device 122 are not illustrated. However, as can be seen in FIG. 7, the variable torque biasing device 122 includes a pair of concentric multi-plate clutches, an inner clutch 124 and an outer clutch 126. As in the previous embodiments, the control assembly 120 is arranged for controlling the actuation of said clutches 124, 126.

The control assembly 120 includes a housing 128 which is mounted on an open end of the variable torque biasing device 122, adjacent the clutches 126, 128. The housing 128 defines a first chamber 130, with an annular transmission member 132 rotatably mounted in the first chamber 130. In use, the transmission member 132 is operably coupled to a single driven input (not illustrated), for example a motor, for causing rotation thereof.

The housing 128 defines a second chamber 134, which is spaced from the first chamber 130, and which is arranged over the open end of the variable torque biasing device 122.

The transmission member 132 includes a tubular shaft portion 135, a lead part of which (indicated at 135A) extends axially into the second chamber 134. A drive control member in the form of an annular plate 136 plate is coupled for rotation with the lead part 134A of the transmission member 132, so as to be rotatable in the second chamber 134. The drive plate 136 defines a plurality of recesses 138, each configured for receiving a portion of a drive member in the form of a ball 140.

The control assembly 120 includes a pair of concentric control members 142, 144, which are arranged for axial displacement relative to the housing 128, for actuation of a respective clutch 124, 126.

Each control member 142, 144 has a control face 146 which is arranged opposite to the drive plate 136. Each control face 146 defines an annular channel 148 for receiving a portion of a respective drive ball 140. In a normal rest position, as illustrated in FIG. 7, the control faces 146 on the control members 142, 144 are generally co-planar, so as to be uniformly spaced from the drive plate 136, with the drive balls 140 held therebetween. The drive plate 136 is substantially fixed against axial movement, and the balls 140 are rotatably received between the recesses 138 in the drive plate 136 and the channel 148 in the respective opposing control member 142, 144.

The drive balls 140 are essentially arranged for rotation with the drive plate 136, whilst remaining in contact with the control face 146 on a respective control member 142, 144.

However, the channels 148 in the control faces 146 define cam tracks having a plurality of ramp sections, so as to create a generally undulating track along which a respective ball 140 can travel, during rotation of the drive plate 136.

As the drive plate 136 is rotated, the balls 140 are caused to travel in the same rotary direction within their respective recess 138. If a ball 140 encounters an upwardly inclined section in a cam track, it will cause the respective control member 142, 144 to be displaced axially in an active direction, to the left as viewed in FIG. 7, so as to increase load in the associated clutch pack. If the ball 140 encounters a downwardly inclined section in the cam track, the respective control member 142, 144 will not be displaced axially, so that the load on the clutch pack remains unchanged. However, if the assembly incorporates a return spring arrangement (for example of known construction in clutches assemblies), the control member will be displaced in an axial release direction, to the left as viewed in FIG. 7, so as to reduce or release load in the associated clutch pack, if encountering a downwardly inclined section in its respective cam track.

The cam tracks are configured in such a manner that rotation of the drive plate 136 in a first rotary direction causes axial displacement of the outer control member, and rotation of the drive plate 136 in a second rotary direction, opposite to said first rotary direction, causes axial displacement of the inner control member. As such, actuation of the inner and outer clutches is mutually exclusive.

The undulating profile of the cam tracks can be configured as required, depending on the modulation requirements of the respective clutches.

It should be noted that the control assemblies of FIGS. 1 to 6 may be operably mounted in a housing generally of the kind illustrated in FIG. 7, for corresponding communication with a pair of concentric clutches in a variable torque biasing device.

1. A control assembly for a pair of concentric clutches, the control assembly having a single input and a pair of outputs, each output arranged for actuation of a respective one of said clutches, a transmission member operable to rotate in response to actuation from said input, a drive member arranged for rotation with the transmission member, and a pair of axially movable control members arranged for operative contact with said drive member, the control members being concentric with one another and said transmission member, wherein a first one of said control members is arranged to be axially displaced by the drive member in response to movement of said transmission member in a second rotary direction, opposite to said first rotary direction, for actuation of their respective outputs.

2. A control assembly according to claim 1, wherein said control members are concentrically mounted about a drive shaft in a vehicle transmission.

3. A control assembly according to claim 2, wherein the clutches are provided for controlling the torque in a differential module for said drive shaft.

4. A control assembly according to claim 1, wherein the transmission member is annular to said control members.

5-8. (canceled)

9. A control assembly according to claim 1, wherein each control member comprises a body having a control portion engagable by said drive member for axial movement thereof, wherein the control portion on a first of said control members is offset from the body, and the body of the other control member includes a recess for receiving the offset control portion of said first control member, for axial movement of said offset control portion within said recess.

10. A control assembly according to claim 9, wherein a cam track is provided in each control portion for engagement by said drive member.

11. (canceled)

12. A control assembly according to claim 1, wherein a first of said control members is arranged on the inner side of a fixed tubular member, and the other of said control members is arranged on the outer side of said fixed tubular member.

13. A control assembly according to claim 1, further comprising a pair of drive members, each drive member being arranged for operative engagement with the or each control member for causing axial displacement of said control member(s).

14. A control assembly according to claim 13, wherein each drive member is movably received in its own cam track provided in the or each control member.

15. A control assembly according to claim 1, wherein the or each drive member is in the form of a pin or roller.

16. A control assembly according to claim 1, wherein the input comprises a rotary motor.

17. A control assembly according to claim 16, wherein the motor has an output shaft which is arranged perpendicular to the axis of movement of the transmission member.

18. A control assembly according to claim 1, wherein the control members are co-axial, each defining a race for receiving a ball or roller type element, the races being co-axial, with a first race radially spaced from the other race, and wherein the drive member includes a first and second ball or roller type elements, the first element being arranged to move within the first race, and the second element being arranged to move within the other race, each race defining a cam track so as to be operable to drive the associated drive member in an axial direction in response to rotation of the drive member.

19. A control assembly according to claim 18, wherein each control member has an axial face, and the ball race on each control member consists of a groove in said axial face.

20. A control assembly according to claim 19, wherein the axial face on a first of said control members is co-planar with the axial face on the other control member, under normal operating conditions.

21-23. (canceled)

24. A control assembly having an input, a transmission member operable to move about an axis in response to actuation from said input, a drive member arranged for movement with the transmission member, and two outputs, each output having its own axially movable control member arranged for operative communication with said drive member for actuation thereof, wherein the control members are arranged to be displaced axially by the drive member in response to movement of said transmission member

25. A control assembly according to claim 24 wherein the input comprises a rotary motor having an output shaft which is arranged perpendicular to the axis of movement of the transmission member.

26. A control assembly according to claim 24 wherein the control members are concentric with one another.

27. A control assembly according to claim 26 wherein the transmission member is annular to said control members.

28. A control assembly according to claim 27 wherein each control member includes a cam track for engagement by the drive member, for controlling movement of the control members in a predetermined manner.

29. A control assembly according to claim 10 wherein the cam track includes first and second ramp sections, and wherein the gradient of the first ramp section differs from the gradient of second ramp section, to provide for different rates of axial displacement.

30. A control assembly according to claim 14 wherein each cam track includes first and second ramp sections, and wherein the gradient of the first ramp section differs from the gradient of second ramp section, to provide for different rates of axial displacement.

31. A control assembly according to claim 18 wherein each cam track includes first and second ramp sections, and wherein the gradient of the first ramp section differs from the gradient of second ramp section, to provide for different rates of axial displacement.

32. A control assembly according to claim 28 wherein each cam track includes first and second ramp sections, and wherein the gradient of the first ramp section differs from the gradient of second ramp section, to provide for different rates of axial displacement.

33. A control assembly according to claim 16 wherein the motor has an output shaft which is arranged parallel to the axis of axial displacement of the control members.

34. A control assembly according to claim 24 wherein the input comprises a rotary motor having an output shaft that is arranged parallel to the axis of axial displacement of the control members.
